(19) United States
(12) Patent Application Publication
(10) Pub. No.: US 2025/0182025 A1
(43) Pub. Date: Jun. 5, 2025

(54) INTELLIGENT HORIZONTAL TRANSPORTATION SYSTEM AND METHOD FOR AUTOMATIC SIDE-LOADING/UNLOADING CONTAINER TARMINAL

(71) Applicant: Tianjin Port Second Container Terminal Co., Ltd., Tianjin (CN)

(72) Inventors: Bin CHU, Tianjin (CN); Guangjun JIAO, Tianjin (CN); Jiemin YANG, Tianjin (CN); Rong YANG, Tianjin (CN); Yanhui GAO, Tianjin (CN); Pei CHEN, Tianjin (CN); Bin WU, Tianjin (CN); Kai ZHANG, Tianjin (CN); Xiwang LIU, Tianjin (CN); Weiyu NING, Tianjin (CN); Jiawei TANG, Tianjin (CN); Miao FENG, Tianjin (CN); Pai PENG, Tianjin (CN); Qiu LI, Tianjin (CN)

(21) Appl. No.: 19/050,079

(22) Filed: Feb. 10, 2025

Related U.S. Application Data
(63) Continuation-in-part of application No. 17/941,007, filed on Sep. 8, 2022.

(30) Foreign Application Priority Data
Sep. 8, 2021 (CN) 202111046886.X

(51) Int. Cl. G06Q 10/0631; G05D 1/246; G05D 1/622; G05D 1/644; G05D 1/65; G05D 1/667; G05D 1/69; G05D 105/20; G05D 107/70; G05D 111/10; G05D 111/30; G06Q 10/047; G06Q 10/083

(52) U.S. Cl. CPC G06Q 10/06316; G05D 1/246; G05D 1/622; G05D 1/644; G05D 1/65; G05D 1/667; G05D 1/69; G06Q 10/047; G06Q 10/083; G05D 2105/20; G05D 2107/70; G05D 2111/10; G05D 2111/30

(57) ABSTRACT

The disclosure provides an intelligent horizontal transportation system for automatic loading or unloading at a container terminal. The system includes a plurality of autonomous transport robots (ATRs) and an ATR control system. The plurality of ATRs are configured to perform horizontal transportation tasks. The ATR control system is in real-time communication with the plurality of ATRs to manage and control the plurality of ATRs; the ATR control system is in real-time communication with a terminal management system, an automated yard crane, and an automated quay crane, so as to coordinate task scheduling between the automated yard cranes, automated quay cranes, and the plurality of ATRs. The ATR control system includes a task scheduling module, a dynamic path planning module, a standardized control interface module, a traffic management module, a lock station management module, a vehicle sequencing module, a charging scheduling module, a parking management module, and a remote driving module.

### CROSS-REFERENCE TO RELATED APPLICATIONS

This application is a continuation-in-part of U.S. Ser. No. 17/941,007 filed on Sep. 8, 2022, now pending, which claims foreign priority to Chinese Patent Application No. 202111046886.X filed Sep. 8, 2021. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, MA 02142.

### BACKGROUND

The disclosure belongs to the field of terminal transportation control, and particularly relates to an intelligent horizontal transportation system for automatic loading or unloading at a container terminal and method for a completely automatic loading/unloading container terminal.

As a key link of a container transportation network, the efficiencies for containers loading/unloading and transportation of a container terminal decide the economic benefit of the whole flow of container transportation, which significantly manifests the core competitiveness of a harbor. Compared with a conventional terminal, an automatic container terminal featuring high efficiency, environmental protection, low labor cost and the like has become an inevitable trend for future development of the container terminal. A shore crane, an ART (Artificial Intelligence Robot of Transportation) and a yard crane are primary devices in loading, unloading and transportation processes of the automatic container terminal, and are interrelated each other. The shore crane is located at the front edge of the terminal and is responsible for loading and unloading containers on a ship, and its efficiency decides the residence time of the ship at the harbor.

The cooperative operation efficiency of the shore crane, the ART and the yard crane of an existing comprehensive container terminal is ordinary, and the technical level of container handling at the shore crane remains to be improved.

### SUMMARY

The objective of the disclosure is to provide an intelligent horizontal transportation system and method for a completely automatic side-loading/unloading container terminal. By means of the intelligent horizontal transportation system, an automatic horizontal transportation vehicle can be adaptive to the demands of various types of operations at the terminal and is in real-time interaction with other systems to complete information transmission and utilization, so that the real-time perceiving and processing abilities of an overall operation system of the terminal are improved.

In one aspect, the disclosure provides an intelligent horizontal transportation system for automatic loading or unloading at a container terminal, the intelligent horizontal transportation system comprising: a plurality of autonomous transport robots (ATRs); and an ATR control system.

The plurality of ATRs are configured to perform horizontal transportation tasks; the ATR control system is in real-time communication with the plurality of ATRs, and is configured to manage and control the plurality of ATRs; the ATR control system is further in real-time communication with a terminal management system, an automated yard crane, and an automated quay crane, so as to coordinate task scheduling between the automated yard cranes, automated quay cranes, and the plurality of ATRs;
the ATR control system comprises a task scheduling module, a dynamic path planning module, a standardized control interface module, a traffic management module, a lock station management module, a vehicle sequencing module, a charging scheduling module, a parking management module, and a remote driving module;
the task scheduling module is configured to determine a horizontal transportation operational plan for loading and unloading ships and shifting containers, generate an initial transport path based on the horizontal transportation operational plan and real-time positions of the plurality of ATRs within the container terminal, optimize the initial transport path based on principles of minimizing operation time and minimizing operation path, and assigns the optimized transport path to at least one ATR;
the dynamic path planning module is configured to generate an up-to-date terminal map of roads in the container terminal, construct a topological representation of the roads, combine kinematic features of the at least one ATR and a dynamic path planning algorithm to generate a real-time task path; wherein, the kinematic features comprise the ability of the at least one ATR to perform sharp turns and crab-mode operation;
the standardized control interface module is configured to generate compatibility between the ATR control system and the plurality of ATRs, and utilizes the Internet of Things (IoT) message queuing telemetry transport (MQTT) communication protocol to perform real-time communication between the ATRs and the ATR control system;
the traffic management module is configured to real-time detect number and positions of external container trucks at an intersection located at an entrance or exit of a storage yard using a vehicle-road coordination technology, and real-time determine a passing order of the ATRs at the intersection based on the real-time number and positions of external container trucks;
the lock station management module is configured to determine number and positions of lock stations based on berthing positions of ships, quantity of lock assembly and disassembly tasks, generate a task list for lock assembly and disassembly based on historical data from prior operations of the ships, and select an optimal lock station for each ATR by utilizing a dynamic allocation algorithm; wherein, during the lock assembly and disassembly process, the module applies a safety management strategy to protect both personnel and equipment, minimizing potential risks during task execution;
the vehicle sequencing module is configured to optimize ATR movement by dynamically adjusting the passing order and speed of the ATRs based on loading mode of the ships and priority level of horizontal transportation tasks, ensuring that the ATRs reach designated areas in an optimal sequence; wherein, when the traffic congestion or equipment failure occurs, the vehicle sequencing module adjusts the passing order of the ATRs or assigns the ATRs to a buffering area;
the charging scheduling module is configured to select a charging station for each ATR based on a battery level of each ATR, energy requirements of the optimized operation task being performed, and the kinematic features of each ATR, automatically align each ATR with the charging station, and optimize the charging time and intensity;
the parking management module is configured to dynamically assign parking areas to the ATRs based on the berthing positions of ships, the priority of ongoing horizontal transportation tasks, and the kinematic features of each ATR, ensuring that the ATRs quickly enter and exit parking areas;
the remote driving module is configured to control the ATRs with varying kinematic features using a standardized control interface, and utilize 5G high-bandwidth, low-latency capabilities to support one-to-many remote supervision and control of the ATRs.

In a class of this embodiment, the task scheduling module is configured to perform ATR real-time monitoring and ATR scheduling; the ATR real-time monitoring comprises: dynamically monitoring the horizontal transportation tasks at the container terminal, the horizontal transportation tasks comprising loading and unloading ships and shifting containers; and dynamically monitoring an operational status, current positions, and driving speeds of all ATRs at the container terminal; and the ATR scheduling comprises: filtering and selecting ATRs having sufficient remaining battery power; and assigning the operation task to each ATR based on the principles of minimizing operation time, minimizing operation path, and congestion avoidance.

In a class of this embodiment, the dynamic path planning module is configured to perform map generation, map layer management, road network topology management, intelligent path planning, traffic congestion prevention, support for multiple kinematic models;
the map generation comprises: collecting, using a mobile measurement device, road information within the container terminal; generating, using a map generation algorithm, a base map of a layout of the container terminal based on the road information; wherein, the map has a horizontal absolute accuracy of 20 cm;
the map layer management comprises: constructing a plurality of dynamic map layers on top of the base map; updating, in real-time, the plurality of dynamic map layers and the base map to form an up-to-date terminal map; wherein the up-to-date terminal map comprises the road information updated at different frequencies, comprising traffic conditions and traffic rules of the container terminal;
the road network topology management comprises: employing a dynamic path generation algorithm and specific conditions of environment of the container terminal to continuously construct an optimal road network topology; wherein, the optimal road network topology is used to assign an optimal route to the ATRs;
the intelligent path planning comprises: generating, using A-star algorithm, a real-time, collision-free, and smooth driving path for the ATRs based on the road network topology, the kinematic features of the ATRs, and the traffic conditions; defining a key interval along the generated driving path; setting specific speed, time windows, and deviation ranges for the ATRs, so as to prevent congestion; wherein, the A-star algorithm is configured to support multiple kinematic models to account for different ATR types and operational constraints;
the traffic congestion prevention comprises: monitoring the real-time position and speed of each ATR; predicting potential congestion at traffic nodes; and dynamically adjusting the driving speed and path of the ATRs;
the A-star algorithm is performed as follows:
the A-star algorithm uses an evaluation function ƒ(n); the evaluation function ƒ(n) is optimized based on the position information of the ATRs; key turning points are extracted, and redundant turning points are removed; the global path is planned by the A-star algorithm as a broken line path; the dynamic window algorithm is applied to adjust and smooth the global path, considering the kinematic features of the ATRs;
a weight function of a heuristic function in the A-star algorithm is recalibrated according to the position information of the ATRs; the evaluation function ƒ(n) is specifically represented as:

$$f ( n ) = g ( n ) + ( 1 + \frac{r}{R} ) h ( n ) ;$$

where, g(n) is the exact cost of a path from a starting point to a node n, also referred to as a cost function; h(n) is a heuristic estimated cost from the node n to the target, also referred to as a heuristic function; r is a distance from a current point to a target point, and R is a distance from the starting point to the target point; the global path obtained by the A-star algorithm is a one-time planned broken line path; and after the broken line path is obtained, the global path obtained by the A-star algorithm is the broken line path planned at one time, so that the operation speed and acceleration of the ATR are unstable and do not comply with the kinematics characteristics of the ATR, and therefore, there is a huge risk in the driving process of the transportation vehicle, easily resulting in the operation fault of the vehicle; the dynamic window algorithm can plan the dynamic smooth path in real time according to the key local path for operation of the ATR to guarantee that the vehicle drives in a stable speed interval and the transportation process is smooth and stable; however, in the real-time dynamic environment, when the dynamic window algorithm is independently used, the ATR easily deviates from the target path, which cannot meet the precision requirement on the path planning algorithm of the ATR;
the improved A-star algorithm is integrated with the dynamic window algorithm, and the dynamic window evaluation function considering the global optimum path is designed specifically as follows:

$$G ( v , w ) = σ ( α \cdot Phead ( v , w ) + β \cdot dist ( v , w ) + γ \cdot vel ( v , w ) )$$

where v is the vehicle speed, w is the angular speed of the ATRs, Phead(v, w) simulates a deviation of an azimuth angle between an endpoint direction of a track and a current target point; the current target point is a sequence point of the global optimum path nearest to the current point in the advancing direction of the ATR, dist(v, w) is the shortest distance from an obstacle on the track of the ATR, vel(v, w) is the evaluation function for the current speed magnitude, σ is a normalization coefficient, and α, β, γ are weight coefficients; the local path planning follows the contour of the global optimum path through the improved evaluation function, so that the matching precision between the local path and the global path is improved;
a specific application process of the spatio-temporal consistent collision-free smooth path planning algorithm that supports the multi-kinematics model is as follows:
S211: analyzing data such as the driving speed, the current path and the key point of each ATR within the container terminal;
S212: establishing a node data table and a path node data table during a path searching process of the A-star algorithm;
S213: calculating evaluated function values for eight direction nodes around the starting point by taking the starting point of the path as a current initial node;
S214: storing the calculated evaluation function values of the current node and the eight direction nodes around are in a sub-node data table; arranging all nodes in an ascending order of the evaluation function values; updating the initial node with the lowest calculated value; and putting the initial node in the path node data table;
S215: storing current optimum node information for the planned path in the path node data table, with the path comprised within the table representing a preliminarily plan;
S216: Repeatedly executing steps S212 to S215 until the endpoint is identified; where the path comprised within the path node data table is the global path planned by the A-star algorithm;
S217: extracting, based on the global path data, the driving speed and the steering angle of the ATR along the key local path;
S218: performing secondary planning of the local path based on the dynamic window algorithm, so as to generate the local planned paths, corresponding speeds for the ATRs in a next stage; and
S219: combining the kinematic model of the ATR with a moving track thereof within a previous unit of time; evaluating all local paths and speeds of the ATR in the next stage by utilizing the dynamic window evaluation function that considers the global optimum path; and selecting the optimum track and speed as the driving plan of the ATR in the next stage.

In a class of this embodiment, the traffic management module is configured to perform real-time ATR perception, ATR real-time prediction, traffic management and control, and humanized information prompting;
the real-time ATR perception comprises: detecting, in real time, the number and position of the external container trucks at an intersection located at an entrance or exit of a storage yard; and detecting, in real time, the position and driving speed of the ATRs;
the ATR real-time prediction comprises: positioning the ATR in real time based on the positioning technology; predicting, using a predictive algorithm, the time when the ATR arrives at target traffic segments based on the driving speed, the position and working status of each ATR; assessing potential traffic congestion ahead of the driving path of each ATR; and adjusting the driving speed or path of the ATRs in real time;
the traffic management and control comprises: determining, in real time, the passing order of the ATRs at the intersection based on the real-time number and positions of external container trucks and the position and driving speed of the ATRs; and
the humanized information prompting comprises: prompting and guiding passing information in real time by utilizing an RFID, a high-speed road bar, a traffic light and an LED screen device installed at the intersection throughout the container terminal to facilitate the transportation operations of the external container trucks.

In a class of this embodiment, the lock station management module is configured to perform lock station arrangement, autonomous path planning, lock station allocation, lock task management, lock station safety management, and automatic lock disassembling and assembling;
the lock station arrangement comprises: dynamically setting the number and position of the lock stations according to the quantity of lock assembly and disassembly tasks, quay crane configuration, and a length of the ship;
the autonomous path planning comprises: dynamically arranging the driving path of the ATR according to the positions of the lock stations, so as to guarantee that a traffic flow in a lock station will not form a dead point;
the lock station allocation comprises: dynamically allocating, using an intelligent allocation algorithm, the ATRs to the lock stations in real time based on the real-time operation status of each lock station, thus ensuring an even distribution of workload across all lock stations and preventing overburdening of any individual station;
the lock task management comprises: determining the number and positions of lock stations based on berthing positions of ships, quantity of lock assembly and disassembly tasks; generating a task list for lock assembly and disassembly based on historical data from prior operations of the ships; and supporting double-person, four-person and intelligent lock disassembling and assembling robot operation modes to assign tasks reasonably;
the lock station safety management comprises: continuously monitoring a safety status of the lock station by using machine vision technology and position detection technology; when detecting the lock station is in an unsafe state, triggering an emergency brake in the ATRs, preventing potential hazards and ensuring personnel safety; and
the automatic lock disassembling and assembling comprises: controlling the ATRs to perform full-automatic lock disassembly and assembly operations.

In a class of this embodiment, the vehicle sequencing module is configured to perform task scheduling and allocation, ATR operation control, ATR reordering management, support for various shipping modes, and support for a SuperTruck mode:
the task scheduling and allocation comprises: sequencing the operation tasks by considering the priority of the operation tasks, the operation time of the ATRs, the position of the ATR, and the driving distance of the ATR;
the ATR operation control comprises: during the driving process, dynamically adjusting the driving speed of the ATRs, so as to ensure that the ATRs arrive at the designated area in a specified order;
the ATR reordering management comprises: after failure of speed regulation and control, regulating the driving order of the ATRs by utilizing a three-level buffering area of the lock station area;
the support for various shipping modes comprises: supporting a strict shipping mode, a flexible shipping mode, and a free shipping mode; and adjusting the driving order of the ATRs according to the requirements of each shipping mode; and
the support for a SuperTruck mode comprises: prioritizing the ATRs executing urgent operation tasks by providing preferential paths and scheduling.

In a class of this embodiment, the charging scheduling module is configured to perform charging management and charging scheduling;
the charging management comprises: determining the charging time and intensity for each ATR based on remaining battery level, the priority and energy requirements of the ongoing operation task; and
the charging scheduling comprises: managing the charging process intelligently by using machine learning and big data analytics, thus minimizing unnecessary charging cycles, and extending the service life of a battery.

In a class of this embodiment, the intelligent parking management module is configured to perform parking area allocation and parking space adjustment;
the parking area allocation comprises: dynamically adjusting the parking areas for the ATRs within the container terminal based on the operation tasks, so as to reduce the driving distance for the ATRs, enhancing overall operational efficiency; and
the parking space adjustment comprises: intelligently adjusting the parking space according to the kinematics features of the ATRs, ensuring that the ATRs quickly enter and exit the parking space.

In another aspect, the disclosure further provides a method for automatic loading or unloading at a container terminal using the above-mentioned intelligent horizontal transportation system, the method comprising:
S1: communicating, by the ATR control system, with a mobile measurement device; acquiring, using a mobile measurement device, road information within the container terminal; generating, by the ATR control system, a base map of a layout of the container terminal based on the road information; constructing, by the ATR control system, a plurality of dynamic map layers on top of the base map; and updating, by the ATR control system, in real-time, the plurality of dynamic map layers and the base map, so as to form an up-to-date terminal map;
S2: monitoring, by the ATR control system, real-time position of each ATR within the container terminal; determining, by the ATR control system, an operation task based on the real-time position of each ATR and an operational plan comprising one or more of shipping, unshipping, and container shifting operations within the container terminal; optimizing, by the ATR control system, the operation task based on principles of minimizing global operation time and minimizing global operation path; and assigning, by the ATR control system, the optimized operation task to the plurality of ATRs within the container terminal;
S3: generating, using the dynamic path planning algorithm within the ATR control system, a real-time task path comprising both a starting point and an endpoint; sending, by the ATR control system, the real-time task path to at least one ATR for execution; and coordinating, using an interval vehicle control technology within the ATR control system, the movement of all ATRs within a key area of the container terminal to prevent a traffic deadlock;
S4: connecting all ATRs to the ATR control system via a standardized control interface; reporting, by each ATR, its position and operational state to the ATR control system in real time; and receiving, by the ATR, the optimized operation task and the real-time task path from the ATR control system;
S5: during a driving process, performing, by the ATR control system, a dynamic path planning and speed adjustment on all ATRs based on the up-to-date terminal map, the real-time position of each ATR, a driving speed of each ATR, and priority level of all ATRs within the container terminal; executing, by each ATR, obstacle avoidance, speed control, and parking actions using onboard sensing devices comprising vehicle-mounted radar and a monocular camera to automatically detect and respond to environmental conditions;
S6: detecting, by the ATR control system, in real time, number and positions of external container trucks at an intersection located at an entrance or exit of a storage yard; determining, by the ATR control system, in real time, a passing order of the ATRs at the intersection based on the real-time number and positions of external container trucks;
S7: evaluating, by the ATR control system, in real time, a working status of each lock station; assigning, by the ATR control system, a lock station and a front buffering area to at least one ATR, based on the real-time working status of each lock station; planning, by the ATR control system, a driving path within the lock station for the ATR, ensuring that the at least one ATR is directed to the assigned lock station; and integrating, by the ATR control system, a safety management strategy during lock assembly and disassembly, to protect both personnel and equipment from potential risks and hazards, ensuring safe operation within the lock station;
S8. after the lock assembly and disassembly is completed, scheduling, by the ATR control system, the ATR to proceed to an operation position at a shore crane or the storage yard for shipping and unshipping operations; if the operation position is occupied by another ATR, assigning, by the ATR control system, a temporary waiting position to the ATR;
S9. during or after the driving process, evaluating, by the ATR control system, a battery level of each ATR and energy requirements of the optimized operation task being performed or scheduled to determine if charging is necessary; when requiring charging, directing, by the ATR control system, the ATR to a charging station for lateral charging; after the charging process is completed, reassigning, by the ATR control system, the ongoing or next operation task to the ATR;
S10: when the ATR completes the optimized operation task and has no subsequent planned tasks, assigning, using the ATR control system, a parking area to the ATR based on a future operation task and priority of the future operation task; docking, by the ATR control system, the ATR in the assigned parking area; and waiting, by the ATR, for the ATR control system to assign the next operation task to the ATR; and
S11: monitoring, by the ATR control system, in real time, the operation of all ATRs using the intelligent traffic management module and the intelligent remote driving module; and remotely diagnosing and addressing, by the ATR control system, any abnormal states or malfunctions of all ATRs.

Compared with a conventional horizontal transportation device management mode, the disclosure processes and adjusts the horizontal transportation operation according to real-time condition information in assigning horizontal transportation tasks of the terminal, thereby guaranteeing smoothness of harbor work and reducing congestion. The disclosure makes the horizontal transportation management flow fully automatic, realizes sustainable operation of the operation system, based on gray level update, multiple protection and a fault recovery mechanism of the system, and adjust the operation plan of the device according to real-time operation data of the harbor, so as to improve the operation efficiency of the whole horizontal transportation system. Meanwhile, the disclosure breaks through the conventional mode to realize the decoupling design of the horizontal transportation device and the system for the first time, is compatible with various different types of horizontal transportation devices through the standard interface, and constructs the open ecosystem, so as to promote unmanned driving technology with high quality in the industry of automatic container terminal.

### DESCRIPTION OF DRAWINGS

FIG. 1 is a structural diagram of a control system of an intelligent horizontal transportation system for a completely automatic side-loading/unloading container terminal provided by an embodiment of the disclosure.

FIG. 2 is a flowchart of an intelligent horizontal transportation method for a completely automatic side-loading/unloading container terminal provided by an embodiment of the disclosure.

FIG. 3 is a design brief diagram of an intelligent horizontal transportation system for a completely automatic side-loading/unloading container terminal provided by an embodiment of the disclosure.

FIG. 4 is a dynamic path planning schematic diagram of an ART in an unstructured scenario provided by an embodiment of the disclosure.

FIG. 5 is a schematic diagram of multiple vehicle cooperation of the ARTs provided by an embodiment of the disclosure.

FIG. 6 is a refined guiding schematic diagram of a specific action of an ART in an allowed deviation range provided by an embodiment of the disclosure.

FIG. 7 is an autonomous path planning schematic diagram of an ART in a straight angle steering scenario provided by an embodiment of the disclosure.

FIG. 8 is an autonomous path planning schematic diagram of an ART in a multiple obstacle avoidance scenario and the like provided by an embodiment of the disclosure.

### DETAILED DESCRIPTION OF THE INVENTION

To further illustrate the disclosure, embodiments detailing an intelligent horizontal transportation system for automatic loading or unloading at a container terminal and method for a completely automatic loading/unloading container terminal are described below. It should be noted that the following embodiments are intended to describe and not to limit the disclosure.

### Example 1

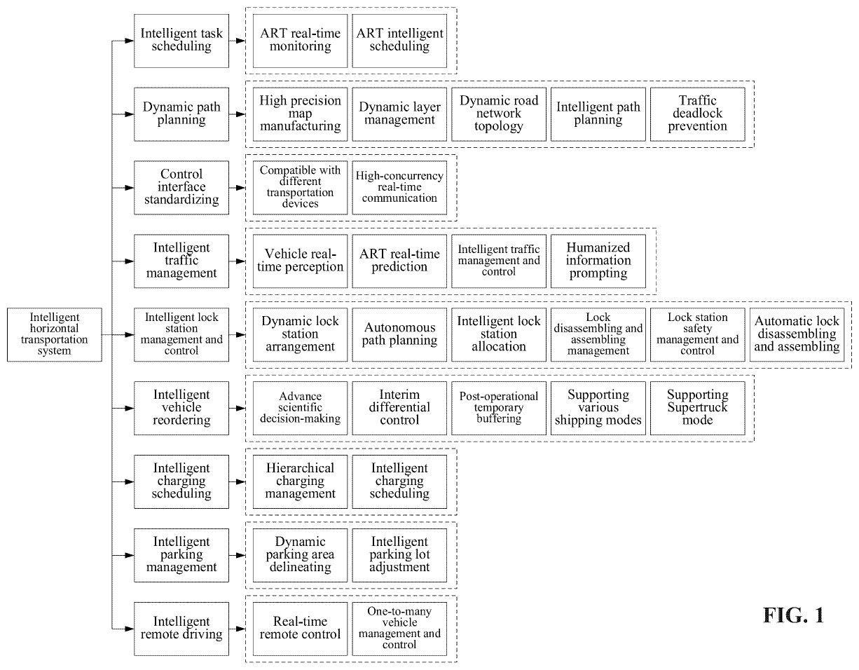

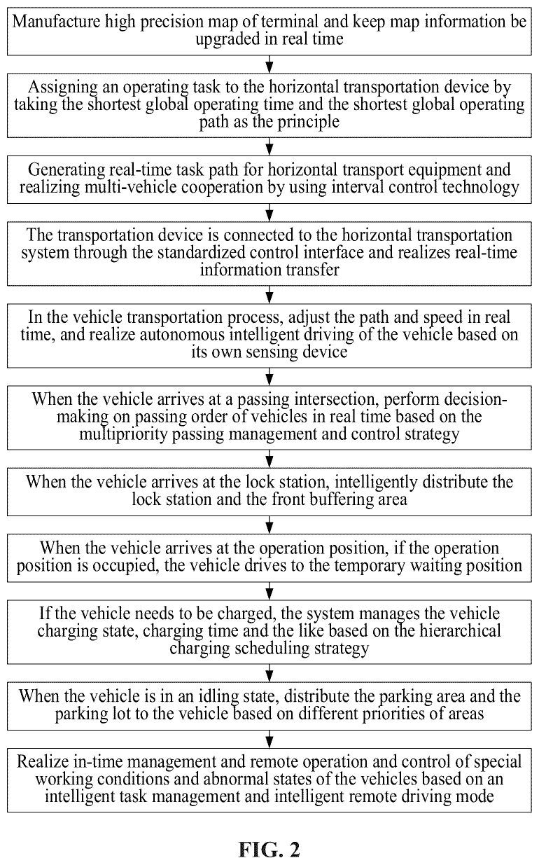

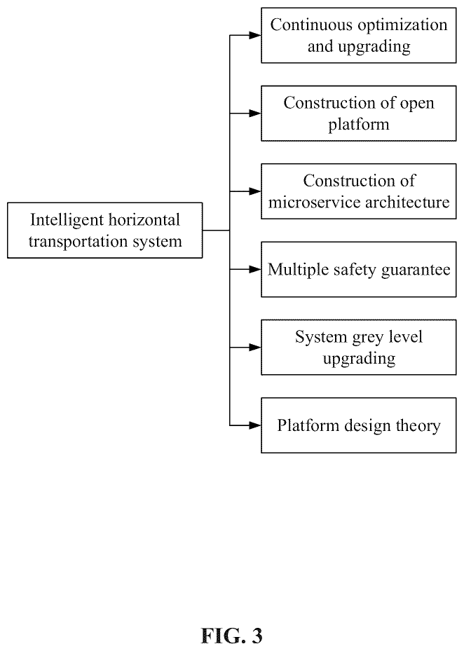

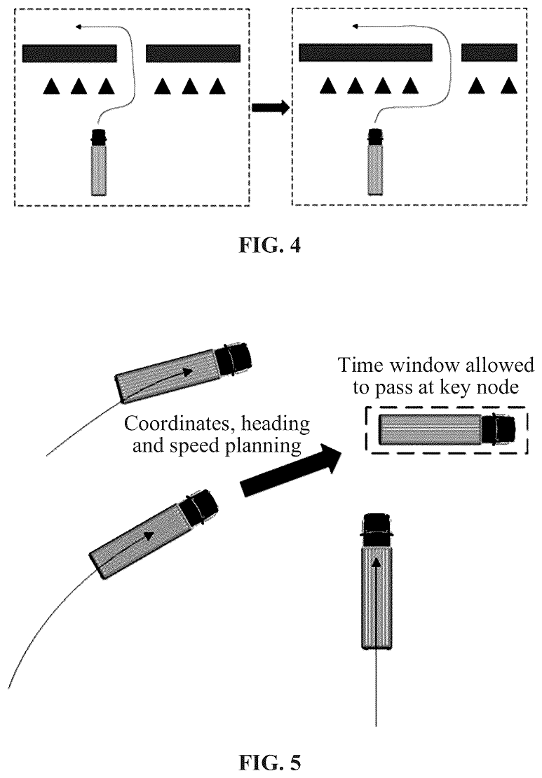

An intelligent horizontal transportation system for automatic loading or unloading at a container terminal comprises a plurality of autonomous transport robots (ATRs); and an ATR control system. The plurality of ATRs are configured to perform horizontal transportation tasks; the ATR control system is in real-time communication with the plurality of ATRs, and is configured to manage and control the plurality of ATRs; the ATR control system is further in real-time communication with a terminal management system, an automated yard crane, and an automated quay crane, so as to coordinate task scheduling between the automated yard cranes, automated quay cranes, and the plurality of ATRs. As shown in FIG. 1, the ATR control system comprises a task scheduling module, a dynamic path planning module, a standardized control interface module, a traffic management module, a lock station management module, a vehicle sequencing module, a charging scheduling module, a parking management module, and a remote driving module.

P1. the task scheduling module is configured to determine a horizontal transportation operational plan for loading and unloading ships and shifting containers, generate an initial transport path based on the horizontal transportation operational plan and real-time positions of the plurality of ATRs within the container terminal, optimize the initial transport path based on principles of minimizing operation time and minimizing operation path, and assigns the optimized transport path to at least one ATR;
specifically, the task scheduling module is configured to perform ATR real-time monitoring and ATR scheduling:
P1.1 the ATR real-time monitoring comprises: dynamically monitoring the horizontal transportation tasks at the container terminal, the horizontal transportation tasks comprising loading and unloading ships and shifting containers; and dynamically monitoring an operational status, current positions, and driving speeds of all ATRs at the container terminal; and
P1.2 the ATR scheduling comprises: filtering and selecting ATRs having sufficient remaining battery power; and assigning the operation task to each ATR based on the principles of minimizing operation time, minimizing operation path, and congestion avoidance.

P2. the dynamic path planning module is configured to generate an up-to-date terminal map of roads in the container terminal, construct a topological representation of the roads, combine kinematic features of the at least one ATR and a dynamic path planning algorithm to generate a real-time task path; wherein, the kinematic features comprise the ability of the at least one ATR to perform sharp turns and crab-mode operation;
specifically, the dynamic path planning module is configured to perform map generation, map layer management, road network topology management, intelligent path planning, traffic congestion prevention, support for multiple kinematic models:
P2.1 the map generation comprises: collecting, using a mobile measurement device, road information within the container terminal; generating, using a map generation algorithm, a base map of a layout of the container terminal based on the road information; wherein, the map has a horizontal absolute accuracy of 20 cm;
P2.2 the map layer management comprises: constructing a plurality of dynamic map layers on top of the base map; updating, in real-time, the plurality of dynamic map layers and the base map to form an up-to-date terminal map; wherein the up-to-date terminal map comprises the road information updated at different frequencies, comprising traffic conditions and traffic rules of the container terminal;
P2.3 the road network topology management comprises: employing a dynamic path generation algorithm and specific conditions of environment of the container terminal to continuously construct an optimal road network topology; wherein, the optimal road network topology is used to assign an optimal route to the ATRs;
P2.4 the intelligent path planning comprises: generating, using A-star algorithm, a real-time, collision-free, and smooth driving path for the ATRs based on the road network topology, the kinematic features of the ATRs, and the traffic conditions; integrating global operation scheduling, global path planning, and local refined guidance to perform single vehicle control; defining a key interval along the generated driving path; setting specific speed, time windows, and deviation ranges for the ATRs, so as to prevent congestion; wherein, the A-star algorithm is configured to support multiple kinematic models to account for different ATR types and operational constraints; and
P2.5 the traffic congestion prevention comprises: monitoring the real-time position and speed of each ATR; predicting potential congestion at traffic nodes; and dynamically adjusting the driving speed and path of the ATRs.

In P2.1 and P2.2, the map generation and the map layer management comprise:
1. Data collection: the mobile measurement equipment is used to collect data from the container terminal, comprising information about the roads, the lock stations, the storage yards, and other scenes within the container terminal.
2. Data processing and update: based on map generation algorithms and processes, the data from the dynamic and complex environment of the container terminal is processed and the map data is updated in real time to reflect the changes.
3. Element identification: using deep learning-based point cloud classification and element recognition, various elements within the map are identified, such as roads, obstacles, and infrastructure.
4. Manual verification: verification is carried out to ensure the accuracy of locations and logical relationships for lane markings, curbs, traffic lights, signs, and virtual roads within the map.
5. Generation of map products: the final map products comprise a static point cloud map, a positioning base map, and a high-precision map.

The high-precision map is created by the high-precision map system. The high-precision map system comprises a map production platform, an equipment information platform, and a map cloud service platform. The map production platform is configured to upload base map data to the map cloud service platform. The equipment information platform is configured to collect and report position data for the quay cranes and the ATRs to the map cloud service platform. The map cloud service platform is configured to send the maps, navigation, and other information to the ATRs.

In P2.4, the global operation scheduling is based on the actual needs of quay crane loading/unloading and horizontal transport operations in a container terminal. The global operation scheduling minimizes the overall operation time of the ATRs, ensuring an allocation of the ATRs to perform horizontal transport operational tasks. The scheduling guarantees the continuity of shipping, unshipping, and container shifting operations within the container terminal, improving the overall operational efficiency.

In P2.4, the global path planning is based on the starting points and ending points of operation tasks, as well as random tasks such as unlocking, in-line machine inspections, and temporary restricted zones. The global path planning process integrates the kinematic features of the ATRs with the usage principles of the roads within the operational environment to generate the most efficient and shortest driving paths for each ATR. The global path planning utilizes an algorithm that supports multiple kinematic models and incorporates a global vehicle control strategy to ensure the ATRs can follow collision-free paths, particularly in complex scenarios involving lane changes, turns, and other dynamic conditions. The global vehicle control strategy ensures that the ATRs do not interfere with each other while performing their respective tasks, thereby reducing congestion at critical path points. As shown in FIG. 5, when multiple ATRs approach a key section of the container terminal, the algorithm uses the priority of the operation tasks to intelligently generate the passing order, driving speed, coordinates, path, and timing of the ATRs, achieving coordinated multi-vehicle driving and avoiding collisions and congestion.

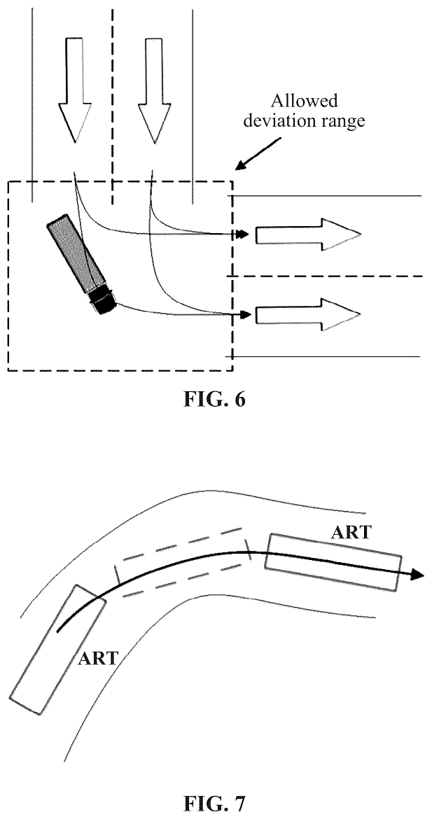

In P2.4, based on the global path control strategy, the local refined guidance controls specific behaviors of ATRs, such as sharp turns, U-turns, lane changes, and reversals. The local refined guidance defines allowable deviation ranges for each of the behaviors and provides precise instructions for the ATRs to execute the required movements. The control facilitates the intelligence control of individual ATR, ensuring efficient horizontal transport operations. Additionally, ATR control points are optimized based on the global path planning, which reduces grid density and alleviates communication network pressure. As shown in FIG. 6, during a sharp turn, the allowable deviation range is set to guide the ATRs to autonomously complete the turning movement. The refined guidance process is based on the ATR's internal control logic and kinematic features, allowing the ATR to independently plan its path, adjust its speed, and manage the timing of the turn.

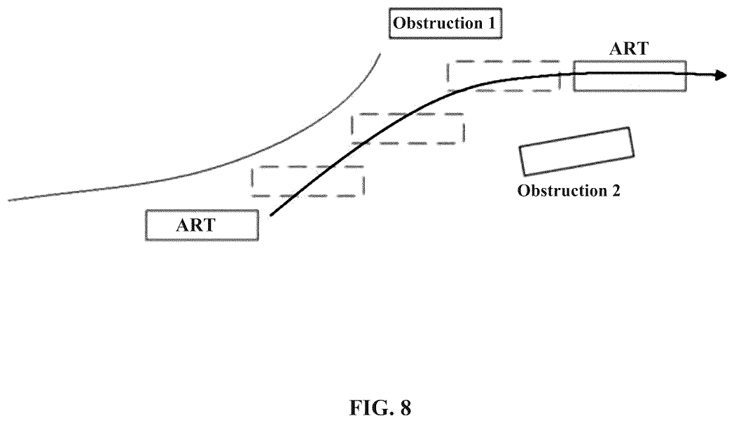

In P2.4, the single vehicle control is based on onboard detection devices, including a monocular camera, radar, and additional sensors, which facilitate the autonomous operation of the ARTs. The ARTs utilize intelligent control algorithms driven by deep learning technologies, in combination with its kinematic features, to autonomously execute a series of maneuvers such as lane changes, obstacle avoidance, speed control, and stopping, all in order to ensure the safety and efficiency of horizontal transport operations. As shown in FIGS. 7 and 8, the ATRs use multiple onboard sensors to construct a real-time SLAM (Simultaneous Localization and Mapping) model of the environment. The ATR's driving control algorithm selects the appropriate obstacle avoidance mode and path. In FIG. 7, when encountering a sharp turn, the ATR applies a static obstacle avoidance method (changing the ATR's heading angle changes, while some of the wheels are steered, and the remaining wheels remain unchanged) to navigate through the turn. In FIG. 8, when facing multiple obstacles, the ATR uses a crab-walking mode (maintaining a fixed heading angle and turning all wheels in the same direction) to autonomously avoid obstacles.

The A-star algorithm is performed as follows:
the A-star algorithm uses an evaluation function ƒ(n); the evaluation function ƒ(n) is optimized based on the position information of the ATRs; key turning points are extracted, and redundant turning points are removed; the global path is planned by the A-star algorithm as a broken line path; the dynamic window algorithm is applied to adjust and smooth the global path, considering the kinematic features of the ATRs;
a weight function of a heuristic function in the A-star algorithm is recalibrated according to the position information of the ATRs; the evaluation function ƒ(n) is specifically represented as:

$$f ( n ) = g ( n ) + ( 1 + \frac{r}{R} ) h ( n ) ;$$

where, g(n) is the exact cost of a path from a starting point to a node n, also referred to as a cost function; h(n) is a heuristic estimated cost from the node n to the target, also referred to as a heuristic function; r is a distance from a current point to a target point, and R is a distance from the starting point to the target point; the global path obtained by the A-star algorithm is a one-time planned broken line path; and after the broken line path is obtained, the global path obtained by the A-star algorithm is the broken line path planned at one time, so that the operation speed and acceleration of the ATR are unstable and do not comply with the kinematics characteristics of the ATR, and therefore, there is a huge risk in the driving process of the transportation vehicle, easily resulting in the operation fault of the vehicle; the dynamic window algorithm can plan the dynamic smooth path in real time according to the key local path for operation of the ATR to guarantee that the vehicle drives in a stable speed interval and the transportation process is smooth and stable; however, in the real-time dynamic environment, when the dynamic window algorithm is independently used, the ATR easily deviates from the target path, which cannot meet the precision requirement on the path planning algorithm of the ATR;
the improved A-star algorithm is integrated with the dynamic window algorithm, and the dynamic window evaluation function considering the global optimum path is designed specifically as follows:

$$G ( v , w ) = σ ( α \cdot Phead ( v , w ) + β \cdot dist ( v , w ) + γ \cdot vel ( v , w ) )$$

where v is the vehicle speed, w is the angular speed of the ATRs, Phead(v, w) simulates a deviation of an azimuth angle between an endpoint direction of a track and a current target point; the current target point is a sequence point of the global optimum path nearest to the current point in the advancing direction of the ATR, dist(v, w) is the shortest distance from an obstacle on the track of the ATR, vel(v, w) is the evaluation function for the current speed magnitude, σ is a normalization coefficient, and α, β, γ are weight coefficients; the local path planning follows the contour of the global optimum path through the improved evaluation function, so that the matching precision between the local path and the global path is improved;
a specific application process of the spatio-temporal consistent collision-free smooth path planning algorithm that supports the multi-kinematics model is as follows:
S211: analyzing data such as the driving speed, the current path and the key point of each ATR within the container terminal;
S212: establishing a node data table and a path node data table during a path searching process of the A-star algorithm;
S213: calculating evaluated function values for eight direction nodes around the starting point by taking the starting point of the path as a current initial node;
S214: storing the calculated evaluation function values of the current node and the eight direction nodes around are in a sub-node data table; arranging all nodes in an ascending order of the evaluation function values; updating the initial node with the lowest calculated value; and putting the initial node in the path node data table;
S215: storing current optimum node information for the planned path in the path node data table, with the path comprised within the table representing a preliminarily plan;
S216: Repeatedly executing steps S212 to S215 until the endpoint is identified; where the path comprised within the path node data table is the global path planned by the A-star algorithm;
S217: extracting, based on the global path data, the driving speed and the steering angle of the ATR along the key local path;
S218: performing secondary planning of the local path based on the dynamic window algorithm, so as to generate the local planned paths, corresponding speeds for the ATRs in a next stage; and
S219: combining the kinematic model of the ATR with a moving track thereof within a previous unit of time; evaluating all local paths and speeds of the ATR in the next stage by utilizing the dynamic window evaluation function that considers the global optimum path; and selecting the optimum track and speed as the driving plan of the ATR in the next stage.

The global path planning specifically comprises:
S201: A grid world is created in the driving area of the ATRs within the container terminal. This involves mapping out the driving paths and marking the starting point, endpoint, and necessary key points along the way that the ATRs must pass through;
S202: the shortest straight-line path is selected for the ATR according to the starting point, the key points along the driving path, and the endpoint of the ATR; in a shore side operation area, the optimum topological relation is dynamically adjusted under a circumstance that the road is closed, and the structured road is generated offline according to obstacles in the site;
S203: the shortest path is fitted to the driving path according to the kinetic characteristics of the vehicle driving by grid line interpolation, and in the fitting process, the grid-level path is prioritized;
S204: in the driving process of the ATR, in all scenarios, the movements of the ATRs are cooperated first by a longitudinal speed planning method, so that multi-vehicle cooperative driving is realized.

P3. the standardized control interface module is configured to generate compatibility between the ATR control system and the plurality of ATRs, and utilizes the Internet of Things (IoT) message queuing telemetry transport (MQTT) communication protocol to perform real-time communication between the ATRs and the ATR control system;

P4. the traffic management module is configured to real-time detect number and positions of external container trucks at an intersection located at an entrance or exit of a storage yard using a vehicle-road coordination technology, and real-time determine a passing order of the ATRs at the intersection based on the real-time number and positions of external container trucks;
Two strategies for dynamically adjusting the passing order and path of the ATRs are as follows:
1. ATR traffic priority: inside the container terminal, the ATRs are given higher priority than the external container trucks. In situations where both an ATR and an external container truck are approaching an intersection or crossing point, the ATR is allowed to pass first.
2. External container truck priority: when the waiting time for an external container truck exceeds 20 minutes or when the number of waiting external container trucks exceeds three, external container trucks are given forced priority to pass.
specifically,
the traffic management module is configured to perform real-time ATR perception, ATR real-time prediction, traffic management and control, and humanized information prompting:
P4.1 the real-time ATR perception comprises: detecting, in real time, the number and position of the external container trucks at an intersection located at an entrance or exit of a storage yard; and detecting, in real time, the position and driving speed of the ATRs;
P4.2 the ATR real-time prediction comprises: positioning the ATR in real time based on the positioning technology; predicting, using a predictive algorithm, the time when the ATR arrives at target traffic segments based on the driving speed, the position and working status of each ATR; assessing potential traffic congestion ahead of the driving path of each ATR; and adjusting the driving speed or path of the ATRs in real time;
P4.3 the traffic management and control comprises: determining, in real time, the passing order of the ATRs at the intersection based on the real-time number and positions of external container trucks and the position and driving speed of the ATRs; and
P4.4 the humanized information prompting comprises: prompting and guiding passing information in real time by utilizing an RFID, a high-speed road bar, a traffic light and an LED screen device installed at the intersection throughout the container terminal to facilitate the transportation operations of the external container trucks.

P5. the lock station management module is configured to determine number and positions of lock stations based on berthing positions of ships, quantity of lock assembly and disassembly tasks, generate a task list for lock assembly and disassembly based on historical data from prior operations of the ships, and select an optimal lock station for each ATR by utilizing a dynamic allocation algorithm; wherein, during the lock assembly and disassembly process, the module applies a safety management strategy to protect both personnel and equipment, minimizing potential risks;
specifically, the lock station management module is configured to perform lock station arrangement, autonomous path planning, lock station allocation, lock task management, lock station safety management, and automatic lock disassembling and assembling;
P5.1 the lock station arrangement comprises: dynamically setting the number and position of the lock stations according to the quantity of lock assembly and disassembly tasks, quay crane configuration, and a length of the ship;
P5.2 the autonomous path planning comprises: dynamically arranging the driving path of the ATR according to the positions of the lock stations, so as to guarantee that a traffic flow in a lock station will not form a dead point;
P5.3 the lock station allocation comprises: dynamically allocating, using an intelligent allocation algorithm, the ATRs to the lock stations in real time based on the real-time operation status of each lock station, thus ensuring an even distribution of workload across all lock stations and preventing overburdening of any individual station.
P5.4 the lock task management comprises: determining the number and positions of lock stations based on berthing positions of ships, quantity of lock assembly and disassembly tasks; generating a task list for lock assembly and disassembly based on historical data from prior operations of the ships; and supporting double-person, four-person and intelligent lock disassembling and assembling robot operation modes to assign tasks reasonably;
P5.5 the lock station safety management comprises: continuously monitoring a safety status of the lock station by using machine vision technology and position detection technology; when detecting the lock station is in an unsafe state, triggering an emergency brake in the ATRs, preventing potential hazards and ensuring personnel safety; and
P5.6 the automatic lock disassembling and assembling comprises: controlling the ATRs to perform full-automatic lock disassembly and assembly operations.

P6. the vehicle sequencing module is configured to optimize ATR movement by dynamically adjusting the passing order and speed of the ATRs based on loading mode of the ships and priority level of horizontal transportation tasks, ensuring that the ATRs reach designated areas in an optimal sequence; wherein, when the traffic congestion or equipment failure occurs, the vehicle sequencing module adjusts the passing order of the ATRs or assigns the ATRs to a buffering area;
specifically, the vehicle sequencing module is configured to perform task scheduling and allocation, ATR operation control, ATR reordering management, support for various shipping modes, and support for a SuperTruck mode:
P6.1 the task scheduling and allocation comprises: sequencing the operation tasks by considering the priority of the operation tasks, the operation time of the ATRs, the position of the ATR, and the driving distance of the ATR;
P6.2 the ATR operation control comprises: during the driving process, dynamically adjusting the driving speed of the ATRs, so as to ensure that the ATRs arrive at the designated area in a specified order;
P6.3 the ATR reordering management comprises: after failure of speed regulation and control, regulating the driving order of the ATRs by utilizing a three-level buffering area of the lock station area;
P6.4 the support for various shipping modes comprises: supporting a strict shipping mode, a flexible shipping mode, and a free shipping mode; and adjusting the driving order of the ATRs according to the requirements of each shipping mode; and
P6.5 the support for a SuperTruck mode comprises: prioritizing the ATRs executing urgent operation tasks by providing preferential paths and scheduling.

P7. the charging scheduling module is configured to select a charging station for each ATR based on a battery level of each ATR, energy requirements of the optimized operation task being performed, and the kinematic features of each ATR, automatically align each ATR with the charging station, and optimize the charging time and intensity of each ATR;
specifically, the charging scheduling module is configured to perform charging management and charging scheduling:
P7.1 the charging management comprises: determining the charging time and intensity for each ATR based on remaining battery level, the priority and energy requirements of the ongoing operation task; and
P7.2 the charging scheduling comprises: managing the charging process intelligently by using machine learning and big data analytics, thus minimizing unnecessary charging cycles, and extending the service life of a battery.

P8. the parking management module is configured to dynamically assign parking areas to the ATRs based on the berthing positions of ships, the priority of ongoing horizontal transportation tasks, and the kinematic features of each ATR, ensuring that the ATRs quickly enter and exit parking areas;
specifically, the intelligent parking management module is configured to perform parking area allocation and parking space adjustment:
P8.1 the parking area allocation comprises: dynamically adjusting the parking areas for the ATRs within the container terminal based on the operation tasks, so as to reduce the driving distance for the ATRs, enhancing overall operational efficiency; and
P8.2 the parking space adjustment comprises: intelligently adjusting the parking space according to the kinematics features of the ATRs, ensuring that the ATRs quickly enter and exit the parking space.

P9. the remote driving module comprises a standard control interface configured to be compatible with the ATRs having different kinematic features;
specifically, the remote driving module is configured to perform real-time remote control and one-to-many ATR control;
P9.1 the real-time remote control comprises controlling the ATRs with varying kinematic features using the standardized control interface; and
P9.2 one-to-many ATR control comprises utilizing 5G high-bandwidth, low-latency capabilities to support one-to-many remote supervision and control of the ATRs.

### Example 2

A method for automatic loading or unloading at a container terminal using the intelligent horizontal transportation system of claim 1, the method comprising:
S1: communicating, by the ATR control system, with a mobile measurement device; acquiring, using a mobile measurement device, road information within the container terminal; generating, by the ATR control system, a base map of a layout of the container terminal based on the road information; constructing, by the ATR control system, a plurality of dynamic map layers on top of the base map; and updating, by the ATR control system, in real-time, the plurality of dynamic map layers and the base map, so as to form an up-to-date terminal map;
S2: monitoring, by the ATR control system, real-time position of each ATR within the container terminal; determining, by the ATR control system, an operation task based on the real-time position of each ATR and an operational plan comprising one or more of shipping, unshipping, and container shifting operations within the container terminal; optimizing, by the ATR control system, the operation task based on principles of minimizing global operation time and minimizing global operation path; and assigning, by the ATR control system, the optimized operation task to the plurality of ATRs within the container terminal;
S3: generating, using the dynamic path planning algorithm within the ATR control system, a real-time task path comprising both a starting point and an endpoint; sending, by the ATR control system, the real-time task path to at least one ATR for execution; and coordinating, using an interval vehicle control technology within the ATR control system, the movement of all ATRs within a key area of the container terminal to prevent a traffic deadlock;
S4: connecting all ATRs to the ATR control system via a standardized control interface; reporting, by each ATR, its position and operational state to the ATR control system in real time; and receiving, by the ATR, the optimized operation task and the real-time task path from the ATR control system;
S5: during a driving process, performing, by the ATR control system, a dynamic path planning and speed adjustment on all ATRs based on the up-to-date terminal map, the real-time position of each ATR, a driving speed of each ATR, and priority level of all ATRs within the container terminal; executing, by each ATR, obstacle avoidance, speed control, and parking actions using onboard sensing devices comprising vehicle-mounted radar and a monocular camera to automatically detect and respond to environmental conditions;
S6: detecting, by the ATR control system, in real time, number and positions of external container trucks at an intersection located at an entrance or exit of a storage yard; determining, by the ATR control system, in real time, a passing order of the ATRs at the intersection based on the real-time number and positions of external container trucks;
S7: evaluating, by the ATR control system, in real time, a working status of each lock station; assigning, by the ATR control system, a lock station and a front buffering area to at least one ATR, based on the real-time working status of each lock station;
planning, by the ATR control system, a driving path within the lock station for the ATR, ensuring that the at least one ATR is directed to the assigned lock station; and integrating, by the ATR control system, a safety management strategy during lock assembly and disassembly, to protect both personnel and equipment from potential risks and hazards, ensuring safe operation within the lock station;
S8. after the lock assembly and disassembly is completed, scheduling, by the ATR control system, the ATR to proceed to an operation position at a shore crane or the storage yard for shipping and unshipping operations; if the operation position is occupied by another ATR, assigning, by the ATR control system, a temporary waiting position to the ATR;
S9. during or after the driving process, evaluating, by the ATR control system, a battery level of each ATR and energy requirements of the optimized operation task being performed or scheduled to determine if charging is necessary; when requiring charging, directing, by the ATR control system, the ATR to a charging station for lateral charging; after the charging process is completed, reassigning, by the ATR control system, the ongoing or next operation task to the ATR;
S10: when the ATR completes the optimized operation task and has no subsequent planned tasks, assigning, using the ATR control system, a parking area to the ATR based on a future operation task and priority of the future operation task; docking, by the ATR control system, the ATR in the assigned parking area; and waiting, by the ATR, for the ATR control system to assign the next operation task to the ATR; and
S11: monitoring, by the ATR control system, in real time, the operation of all ATRs using the intelligent traffic management module and the intelligent remote driving module; and remotely diagnosing and addressing, by the ATR control system, any abnormal states or malfunctions of all ATRs.

It will be obvious to those skilled in the art that changes and modifications may be made, and therefore, the aim in the appended claims is to cover all such changes and modifications.

What is claimed is:

1. An intelligent horizontal transportation system for automatic loading or unloading at a container terminal, the intelligent horizontal transportation system comprising:
a plurality of autonomous transport robots (ATRs); and
an ATR control system;
wherein:
the plurality of ATRs are configured to perform horizontal transportation tasks; the ATR control system is in real-time communication with the plurality of ATRs, and is configured to manage and control the plurality of ATRs; the ATR control system is further in real-time communication with a terminal management system, an automated yard crane, and an automated quay crane, so as to coordinate task scheduling between the automated yard cranes, automated quay cranes, and the plurality of ATRs;
the ATR control system comprises a task scheduling module, a dynamic path planning module, a standardized control interface module, a traffic management module, a lock station management module, a vehicle sequencing module, a charging scheduling module, a parking management module, and a remote driving module;
the task scheduling module is configured to determine a horizontal transportation operational plan for loading and unloading ships and shifting containers, generate an initial transport path based on the horizontal transportation operational plan and real-time positions of the plurality of ATRs within the container terminal, optimize the initial transport path based on principles of minimizing operation time and minimizing operation path, and assigns an optimized transport path to at least one ATR;
the dynamic path planning module is configured to generate an up-to-date terminal map of roads in the container terminal, construct a topological representation of the roads, combine kinematic features of the at least one ATR and a dynamic path planning algorithm to generate a real-time task path; wherein, the kinematic features comprise the ability of the at least one ATR to perform sharp turns and crab-mode operation;
the standardized control interface module is configured to generate compatibility between the ATR control system and the plurality of ATRs, and utilizes the Internet of Things (IoT) message queuing telemetry transport (MQTT) communication protocol to perform real-time communication between the ATRs and the ATR control system;
the traffic management module is configured to real-time detect number and positions of external container trucks at an intersection located at an entrance or exit of a storage yard using a vehicle-road coordination technology, and real-time determine a passing order of the ATRs at the intersection based on the real-time number and positions of external container trucks;
the lock station management module is configured to determine number and positions of lock stations based on berthing positions of ships, quantity of lock assembly and disassembly tasks, generate a task list for lock assembly and disassembly based on historical data from prior operations of the ships, and select an optimal lock station for each ATR by utilizing a dynamic allocation algorithm; wherein, during a lock assembly and disassembly process, the module applies a safety management strategy to protect both personnel and equipment, minimizing potential risks during task execution;
the vehicle sequencing module is configured to optimize ATR movement by dynamically adjusting the passing order and speed of the ATRs based on loading mode of the ships and priority level of horizontal transportation tasks, ensuring that the ATRs reach designated areas in an optimal sequence; wherein, when the traffic congestion or equipment failure occurs, the vehicle sequencing module adjusts the passing order of the ATRs or assigns the ATRs to a buffering area;
the charging scheduling module is configured to select a charging station for each ATR based on a battery level of each ATR, energy requirements of an optimized operation task being performed, and the kinematic features of each ATR, automatically align each ATR with the charging station, and optimize the charging time and intensity;
the parking management module is configured to dynamically assign parking areas to the ATRs based on the berthing positions of ships, the priority of ongoing horizontal transportation tasks, and the kinematic features of each ATR, ensuring that the ATRs enter and exit parking areas;
the remote driving module is configured to control the ATRs with varying kinematic features using a standardized control interface, and utilize 5G high-bandwidth, low-latency capabilities to support one-to-many remote supervision and control of the ATRs.

2. The intelligent horizontal transportation of claim 1, wherein the task scheduling module is configured to perform ATR real-time monitoring and ATR scheduling;
the ATR real-time monitoring comprises: dynamically monitoring the horizontal transportation tasks at the container terminal, the horizontal transportation tasks comprising loading and unloading ships and shifting containers; and dynamically monitoring an operational status, current positions, and driving speeds of all ATRs at the container terminal; and
the ATR scheduling comprises: filtering and selecting ATRs having sufficient remaining battery power; and assigning an operation task to each ATR based on the principles of minimizing operation time, minimizing operation path, and congestion avoidance.

3. The intelligent horizontal transportation of claim 1, wherein the dynamic path planning module is configured to perform map generation, map layer management, road network topology management, intelligent path planning, traffic congestion prevention, support for multiple kinematic models;
the map generation comprises: collecting, using a mobile measurement device, road information within the container terminal; generating, using a map generation algorithm, a base map of a layout of the container terminal based on the road information; wherein, the base map has a horizontal absolute accuracy of 20 cm;
the map layer management comprises: constructing a plurality of dynamic map layers on top of the base map; updating, in real-time, the plurality of dynamic map layers and the base map to form an up-to-date terminal map; wherein the up-to-date terminal map comprises the road information updated at different frequencies, comprising traffic conditions and traffic rules of the container terminal;
the road network topology management comprises: employing a dynamic path generation algorithm and specific conditions of environment of the container terminal to continuously construct an optimal road network topology; wherein, the optimal road network topology is used to assign an optimal route to the ATRs;
the intelligent path planning comprises: generating, using A-star algorithm, a real-time, collision-free, and smooth driving path for the ATRs based on the road network topology, the kinematic features of the ATRs, and the traffic conditions; defining a key interval along the generated driving path; setting specific speed, time windows, and deviation ranges for the ATRs, so as to prevent congestion; wherein, the A-star algorithm is configured to support multiple kinematic models to account for different ATR types and operational constraints;
the traffic congestion prevention comprises: monitoring the real-time position and speed of each ATR; predicting potential congestion at traffic nodes; and dynamically adjusting the driving speed and path of the ATRs;
the A-star algorithm is performed as follows:
the A-star algorithm uses an evaluation function ƒ(n); the evaluation function ƒ(n) is optimized based on position information of the ATRs; key turning points of the position information are extracted, and redundant turning points are removed; a global path is planned by the A-star algorithm as a broken line path; a dynamic window algorithm is applied to adjust and smooth the global path, considering the kinematic features of the ATRs;
a weight function of a heuristic function in the A-star algorithm is recalibrated according to the position information of the ATRs; the evaluation function ƒ(n) is specifically represented as:
$$f ( n ) = g ( n ) + ( 1 + \frac{r}{R} ) h ( n ) ;$$
where, g(n) is an exact cost of a path from a starting point to a node n, also referred to as a cost function; h(n) is a heuristic estimated cost from the node n to a target point, also referred to as a heuristic function; r is a distance from a current point to the target point, and R is a distance from the starting point to the target point;
the global path obtained by the A-star algorithm is a one-time planned broken line path, and after the broken line path is obtained, the dynamic window algorithm and the A-start algorithm are combined to plan a dynamic smooth path in real time according to a key local path for operation of the ART, to guarantee that vehicles drive in a stable speed interval and the transportation process is smooth and stable;
the improved A-star algorithm is integrated with the dynamic window algorithm, and the dynamic window evaluation function considering the global optimum path is designed specifically as follows:
$$G ( v , w ) = σ ( α \cdot Phead ( v , w ) + β \cdot dist ( v , w ) + γ \cdot vel ( v , w ) )$$
where v is a vehicle speed, w is an angular speed of the ATRs, Phead(v, w) simulates a deviation of an azimuth angle between an endpoint direction of a track and a current target point; the current target point is a sequence point of the global optimum path nearest to the current point in the advancing direction of the ATR, dist(v, w) is the shortest distance from an obstacle on the track of the ATR, vel(v, w) is the evaluation function for a current speed magnitude, σ is a normalization coefficient, and α, β, γ are weight coefficients; a local path planning follows the contour of the global optimum path through the improved evaluation function, so that the matching precision between the local path and the global path is improved;
a specific application process of a spatio-temporal consistent collision-free smooth path planning algorithm that supports a multi-kinematics model is as follows:
S211: analyzing data comprising the driving speed, the current path and the key point of each ATR within the container terminal;
S212: establishing a node data table and a path node data table during a path searching process of the A-star algorithm;
S213: calculating evaluated function values for eight direction nodes around the starting point by taking the starting point of the path as a current initial node;
S214: storing the calculated evaluation function values of the current node and the eight direction nodes around are in a sub-node data table; arranging all nodes in an ascending order of the evaluation function values; updating the initial node with the lowest calculated value; and putting the initial node in the path node data table;
S215: storing current optimum node information for the planned path in the path node data table, with the path comprised within the table representing a preliminarily plan;
S216: repeatedly executing steps S212 to S215 until an endpoint is identified; where the path comprised within the path node data table is the global path planned by the A-star algorithm;
S217: extracting, based on the global path data, the driving speed and the steering angle of the ATR along the key local path;
S218: performing secondary planning of the local path based on the dynamic window algorithm, so as to generate the local planned paths, corresponding speeds for the ATRs in a next stage; and
S219: combining the kinematic model of the ATR with a moving track thereof within a previous unit of time; evaluating all local paths and speeds of the ATR in the next stage by utilizing the dynamic window evaluation function that considers the global optimum path; and selecting an optimum track and speed as the driving plan of the ATR in the next stage.

4. The intelligent horizontal transportation of claim 1, wherein the traffic management module is configured to perform real-time ATR perception, ATR real-time prediction, traffic management and control, and humanized information prompting;
the real-time ATR perception comprises: detecting, in real time, the number and position of the external container trucks at an intersection located at an entrance or exit of a storage yard; and detecting, in real time, the position and driving speed of the ATRs;
the ATR real-time prediction comprises: positioning the ATR in real time based on the positioning technology; predicting, using a predictive algorithm, the time when the ATR arrives at target traffic segments based on the driving speed, the position and working status of each ATR; assessing potential traffic congestion ahead of the driving path of each ATR; and adjusting the driving speed or path of the ATRs in real time;
the traffic management and control comprises: determining, in real time, the passing order of the ATRs at the intersection based on the real-time number and positions of external container trucks and the position and driving speed of the ATRs; and
the humanized information prompting comprises: prompting and guiding passing information in real time by utilizing a radio frequency identification device (RFID), a high-speed road bar, a traffic light and an LED screen device installed at the intersection throughout the container terminal to facilitate the transportation operations of the external container trucks.

5. The intelligent horizontal transportation system of claim 1, wherein the lock station management module is configured to perform lock station arrangement, autonomous path planning, lock station allocation, lock task management, lock station safety management, and automatic lock disassembling and assembling;
the lock station arrangement comprises: dynamically setting the number and position of the lock stations according to the quantity of lock assembly and disassembly tasks, quay crane configuration, and a length of the ship;
the autonomous path planning comprises: dynamically arranging the driving path of the ATR according to the positions of the lock stations, so as to guarantee that a traffic flow in a lock station will not form a dead point;
the lock station allocation comprises: dynamically allocating, using an intelligent allocation algorithm, the ATRs to the lock stations in real time based on the real-time operation status of each lock station, thus ensuring an even distribution of workload across all lock stations and preventing overburdening of any individual station;
the lock task management comprises: determining the number and positions of lock stations based on berthing positions of ships, quantity of lock assembly and disassembly tasks; generating a task list for lock assembly and disassembly based on historical data from prior operations of the ships; and supporting double-person, four-person and intelligent lock disassembling and assembling robot operation modes to assign tasks reasonably;
the lock station safety management comprises: continuously monitoring a safety status of the lock station by using machine vision technology and position detection technology; when detecting the lock station is in an unsafe state, triggering an emergency brake in the ATRs, preventing potential hazards and ensuring personnel safety; and
the automatic lock disassembling and assembling comprises: controlling the ATRs to perform full-automatic lock disassembly and assembly operations.

6. The intelligent horizontal transportation system of claim 1, wherein the vehicle sequencing module is configured to perform task scheduling and allocation, ATR operation control, ATR reordering management, support for various shipping modes, and support for a SuperTruck mode:
the task scheduling and allocation comprises: sequencing operation tasks by considering the priority of the operation tasks, the operation time of the ATRs, the position of the ATR, and a driving distance of the ATR;
the ATR operation control comprises: during the driving process, dynamically adjusting the driving speed of the ATRs, so as to ensure that the ATRs arrive at the designated area in a specified order;
the ATR reordering management comprises: after failure of speed regulation and control, regulating a driving order of the ATRs by utilizing a three-level buffering area of the lock station area;
the support for various shipping modes comprises: supporting a strict shipping mode, a flexible shipping mode, and a free shipping mode; and adjusting the driving order of the ATRs according to the requirements of each shipping mode; and
the support for a SuperTruck mode comprises: prioritizing the ATRs executing urgent operation tasks by providing preferential paths and scheduling.

7. The intelligent horizontal transportation system of claim 1, wherein the charging scheduling module is configured to perform charging management and charging scheduling;
the charging management comprises: determining the charging time and intensity for each ATR based on remaining battery level, the priority and energy requirements of the ongoing operation task; and
the charging scheduling comprises: managing the charging process intelligently by using machine learning and big data analytics, thus minimizing unnecessary charging cycles, and extending the service life of a battery.

8. The intelligent horizontal transportation system of claim 1, wherein the intelligent parking management module is configured to perform parking area allocation and parking space adjustment;
the parking area allocation comprises: dynamically adjusting the parking areas for the ATRs within the container terminal based on the operation tasks, so as to reduce the driving distance for the ATRs, enhancing overall operational efficiency; and
the parking space adjustment comprises: intelligently adjusting the parking space according to the kinematics features of the ATRs, ensuring that the ATRs quickly enter and exit the parking space.

9. A method for automatic loading or unloading at a container terminal using the intelligent horizontal transportation system of claim 1, the method comprising:
S1: communicating, by the ATR control system, with a mobile measurement device; acquiring, using a mobile measurement device, road information within the container terminal; generating, by the ATR control system, a base map of a layout of the container terminal based on the road information; constructing, by the ATR control system, a plurality of dynamic map layers on top of the base map; and updating, by the ATR control system, in real-time, the plurality of dynamic map layers and the base map, so as to form an up-to-date terminal map;
S2: monitoring, by the ATR control system, real-time position of each ATR within the container terminal; determining, by the ATR control system, an operation task based on the real-time position of each ATR and an operational plan comprising one or more of shipping, unshipping, and container shifting operations within the container terminal; optimizing, by the ATR control system, the operation task based on principles of minimizing global operation time and minimizing global operation path; and assigning, by the ATR control system, the optimized operation task to the plurality of ATRs within the container terminal;
S3: generating, using the dynamic path planning algorithm within the ATR control system, a real-time task path comprising both a starting point and an endpoint; sending, by the ATR control system, the real-time task path to at least one ATR for execution; and coordinating, using an interval vehicle control technology within the ATR control system, the movement of all ATRs within a key area of the container terminal to prevent a traffic deadlock;
S4: connecting all ATRs to the ATR control system via a standardized control interface; reporting, by each ATR, its position and operational state to the ATR control system in real time; and receiving, by the ATR, the optimized operation task and the real-time task path from the ATR control system;
S5: during a driving process, performing, by the ATR control system, a dynamic path planning and speed adjustment on all ATRs based on the up-to-date terminal map, the real-time position of each ATR, a driving speed of each ATR, and priority level of all ATRs within the container terminal; executing, by each ATR, obstacle avoidance, speed control, and parking actions using onboard sensing devices comprising vehicle-mounted radar and a monocular camera to automatically detect and respond to environmental conditions;
S6: detecting, by the ATR control system, in real time, number and positions of external container trucks at an intersection located at an entrance or exit of a storage yard; determining, by the ATR control system, in real time, a passing order of the ATRs at the intersection based on the real-time number and positions of external container trucks;
S7: evaluating, by the ATR control system, in real time, a working status of each lock station; assigning, by the ATR control system, a lock station and a front buffering area to at least one ATR, based on the real-time working status of each lock station; planning, by the ATR control system, a driving path within the lock station for the ATR, ensuring that the at least one ATR is directed to the assigned lock station; and integrating, by the ATR control system, a safety management strategy during lock assembly and disassembly, to protect both personnel and equipment from potential risks and hazards, ensuring safe operation within the lock station;
S8: after the lock assembly and disassembly is completed, scheduling, by the ATR control system, the ATR to proceed to an operation position at a shore crane or the storage yard for shipping and unshipping operations; if the operation position is occupied by another ATR, assigning, by the ATR control system, a temporary waiting position to the ATR;
S9: during or after the driving process, evaluating, by the ATR control system, a battery level of each ATR and energy requirements of the optimized operation task being performed or scheduled to determine if charging is necessary; when requiring charging, directing, by the ATR control system, the ATR to a charging station for lateral charging; after the charging process is completed, reassigning, by the ATR control system, the ongoing or next operation task to the ATR;
S10: when the ATR completes the optimized operation task and has no subsequent planned tasks, assigning, using the ATR control system, a parking area to the ATR based on a future operation task and priority of the future operation task; docking, by the ATR control system, the ATR in the assigned parking area; and waiting, by the ATR, for the ATR control system to assign the next operation task to the ATR; and
S11: monitoring, by the ATR control system, in real time, the operation of all ATRs using the intelligent traffic management module and the intelligent remote driving module; and remotely diagnosing and addressing, by the ATR control system, any abnormal states or malfunctions of all ATRs.
